(19) United States
(12) Patent Application Publication
(10) Pub. No.: US 2026/0227183 A1
(43) Pub. Date: Aug. 6, 2026

(54) DEVICE AND METHOD FOR MEASURING ALIGNMENT ERRORS OF A DIRECTED BEAM SOURCE

(71) Applicant: TRIOPTICS GmbH, Wedel (DE)

(72) Inventors: Christian BUSS, Wedel (DE); Kim-Philip WIESE, Wedel (DE)

(73) Assignee: TRIOPTICS GmbH, Wedel (DE)

(21) Appl. No.: 19/154,919

(22) PCT Filed: Feb. 5, 2024
(86) PCT No.: PCT/EP2024/052724

§ 371 Date: Aug. 8, 2025

(30) Foreign Application Priority Data
Feb. 9, 2023 (DE) 10 2023 103 144.9

(51) Int. Cl. G01B 11/27

(52) U.S. Cl. CPC G01B 11/272

(57) ABSTRACT

A device for measuring alignment errors of a laser diode or any other directed beam source comprises a mounting for the beam source. The device also comprises a first spatially resolving radiation sensor, a beam splitter that splits a beam generated by the beam source into a first component beam and a second component beam, and a focusing optics unit arranged in a beam path of the first component beam and has a focal plane in which the first radiation sensor is arranged. A second spatially resolving radiation sensor is arranged in a beam path of the second component beam. A tilt and a lateral offset of the beam generated by the beam source is calculated using first locations on the first radiation sensor that the first component beam sweeps over and using second locations on the second radiation sensor that the second component beam sweeps over.

### BACKGROUND OF THE INVENTION

### 1. Field of the Invention

The invention relates to a device and a method for measuring alignment errors of laser diodes and similar directed beam sources. The alignment errors may be tilts or displacements in particular.

### 2. Description of the Prior Art

Laser diodes and similar directed beam sources are frequently secured in a mounting by adhesive bonding or the like, and said mounting is subsequently installed in an overarching optical system. The external surface of the mounting has been mechanically processed precisely, and this allows the mounting to be installed into the overarching optical system in a desired alignment.

Alignment errors that adversely affect the function of the optical system may arise during the installation of the mounting into said optical system if the optical axis of the beam source is not exactly flush with the mechanical axis of the mounting. Therefore, it is known practice to adjust the beam source before it is adhesively bonded into the mounting.

However, this type of adjustment is complicated and significantly increases the costs of the component.

WO 2019/224346 A2 has disclosed the practice of rotating the mounting with the activated beam source about an axis of rotation and observing the circular movements of the radiation spot that is created on a radiation sensor in two spaced apart planes. Alignment errors can be inferred from the diameters of the circles of incidence detected by the radiation sensor. The planes are generated or defined by adapting the back focal length of the light beams with the aid of a variable optics unit. Should the measured alignment errors not be tolerable, the external surface of the mounting is postprocessed by machining, by turning, milling or grinding (known as fine adjustment operations, e.g. fine turning), until the mechanical axis of the mounting is flush with the optical axis of the beam source.

The pose of the optical axis of the beam source can only be measured sequentially using the known method since the intensity in the two planes must be detected in succession.

### SUMMARY OF THE INVENTION

The problem addressed by the invention is therefore that of specifying a device and a method for measuring alignment errors of directed beam sources, by means of which the required measurement time may be shortened.

In relation to the device, this problem is solved by a device for measuring alignment errors of a directed beam source, comprising a mounting for the beam source, a first spatially resolving radiation sensor and a beam splitter configured to split a beam generated by the beam source into a first component beam and a second component beam. The device also comprises a focusing optics unit arranged in a beam path of the first component beam and having a focal plane in which the first radiation sensor is arranged. A second spatially resolving radiation sensor is arranged in a beam path of the second component beam. A drive of the device is configured to bring about relative movement about an axis of rotation between firstly the mounting and secondly the other parts of the device. A computing means is configured to calculate a tilt and a lateral offset of the beam generated by the beam source, the calculation using first locations on the first radiation sensor that the first component beam sweeps over during a rotation of the beam source relative to the other parts of the device listed above and using second locations on the second radiation sensor that the second component beam sweeps over during the rotation of the beam source relative to the other parts of the device listed above.

The invention is based on the insight that the tilt and the offset of the beam generated by the beam source can be measured simultaneously and independently of one another if the beam is divided into two component beams and if the location of the focus of the first component beam is detected with a first radiation sensor during a rotation of the mounting about an axis of rotation. By contrast, the second component beam is detected by a second radiation sensor but not focused. Measuring tilt and offset at the same time allows the required measurement time to be reduced significantly.

Since the directed beam is largely collimated, focusing the first component beam with the aid of the focusing optics unit causes angles to be translated into locations on the first radiation sensor. All beams incident on the focusing optics unit along the same direction of incidence are consequently focused on the same point, the position of which on the first radiation sensor is specified by the direction of incidence. A lateral offset of the beam does not change the direction of incidence and therefore does not have an effect on this part of the measurement.

By contrast, the location at which the non-focused beam is incident on the second radiation sensor depends on both the offset and the tilt of the beam. Since the tilt is measured by the first radiation sensor, this tilt can easily be removed by calculation from the measurement by the second radiation sensor, and so this second part of the measurement sup-plies the lateral offset between the mechanical axis of the mounting and the optical axis of the beam.

The alignment of the radiation sensors with respect to the axis of rotation is not important during the two partial measurements since it is only the diameter of the circle of incidence arising in each case that is evaluated. The position of the circle of incidence on the respective radiation sensor is not required to calculate the tilt and the offset.

If the device contains an imaging optics unit that is arranged in the beam path of the second component beam and configured to image the beam source onto the second radiation sensor, then the tilt need not be removed by calculation when calculating the offset since the location at which the second component beam is incident on the second radiation sensor in that case depends only on the offset and not on the tilt.

Should such an imaging optics unit be provided, the latter may be configured to image the beam source onto the second radiation sensor in either demagnified or magnified fashion. Whether a demagnification or a magnification is decided upon depends inter alia on the radiation sensor used and on the properties of the beam, e.g. its diameter and its intensity profile. A large beam cross section may be helpful to detect small displacements, but the sensor area must be sufficiently large in this case. Given an intensity profile that deviates significantly from a Gaussian shape and optionally has secondary maxima, large diameters may make the determination of its position on the sensor difficult, and so a demagnification may be sensible in such a case. The imaging scale is usually fixedly predetermined, but it may also be variably adjustable.

In addition to that or in an alternative, the device may contain an afocal optics unit, e.g. in the form of a Kepler telescope, which is arranged in the beam path of the beam generated by the beam source, of the first component beam or of the second component beam. The angle and/or the diameter of the beams may be set with the aid of the afocal optics unit.

It is advantageous if the device comprises a beam deflection unit that deflects the second component beam in such a way that the deflected second component beam runs at least approximately parallel to the first component beam. This allows a mechanically particularly compact construction of the device. For example, the beam deflection unit may be a deflection prism or a deflection mirror.

By preference, only the mounting with the beam source accommodated therein is put into rotation by the drive. However, the mounting with the beam source remaining stationary and an arrangement comprising the beam splitter, the focusing optics unit and the radiation sensors being rotated about the axis of rotation also comes into consideration.

Once the tilt and the offset have been measured, the beam source may be aligned vis-à-vis the axis of rotation such that the remaining residual alignment errors are tolerable.

Should the beam source and the mounting have already been adhesively bonded to each other before the measurement is performed, the mounting may be postprocessed in order to modify the mechanical axis thereof. To this end, the device comprises a machining tool that is configured to process an external surface of the beam source mounting in such a way that a mechanical longitudinal axis of the mounting runs parallel to the optical axis of the beam source. Such tools are known from conventional fine turning.

By contrast, if the measurement is performed before beam source and mounting are connected, then the measurement results may be used to initially align the beam source and the mounting optimally relative to each other and only then adhesively bond these parts to each other. A directional adhesion process may be used in this context. Here, a dispenser is used to initially provide an adhesive in the interspace between the beam source and the mounting prior to the measurement and the final alignment. By preference, the spatial pose of the mounting is initially measured in optical or tactile fashion in a preceding step. In so doing, the mounting may be brought into a desired position, e.g. relative to the axis of rotation or any other mechanical reference. Subsequently, the beam source is aligned relative to the mounting using the device according to the invention and an alignment chuck, hexapod, piezo actuator or any other suitable alignment means. Aligning is performed until the tolerance specifications as regards translation and rotation are met. The adhesive is cured with the aid of a UV light source after the alignment process has been completed.

A method that serves to measure alignment errors of a directed beam source and solves the problem of the invention includes the following steps:
a) the beam source is inserted into a mounting, and a relative rotation about an axis of rotation is generated;
b) concurrently with step a), a beam generated by the beam source is split into a first component beam and a second component beam by a beam splitter;
c) by means of a focusing optics unit, the first component beam is directed at a first spatially resolving radiation sensor arranged in a focal plane of the focusing optics unit;
d) the second component beam is directed at a second spatially resolving radiation sensor;
e) a tilt and a lateral offset of the beam generated by the beam source are calculated using first locations on the first radiation sensor that the first component beam sweeps over during the relative rotation and using second locations on the second radiation sensor that the second component beam sweeps over during the relative rotation of the beam source.

### BRIEF DESCRIPTION OF THE DRAWINGS

Exemplary embodiments of the invention will be explained in detail below on the basis of the drawings. In said drawings:

FIG. 1a shows a schematic illustration of a device according to the invention according to a first exemplary embodiment, the implication being that the optical axis of the beam runs coaxially with the axis of rotation;

FIG. 1b shows a top view of the first radiation sensor and the focus generated there;

FIG. 1c shows a top view of the second radiation sensor and the light spot generated there;

FIGS. 2a to 2c show illustrations corresponding to FIGS. 1a to 1c for the case where the beam generated by the laser diode is laterally offset;

FIGS. 3a to 3c show the device shown in FIGS. 1a to 1c for the case where the light beam generated by the laser diode is tilted;

FIGS. 4a to 4c show a device according to a second exemplary embodiment in illustrations based on FIGS. 1a to 1c; and

FIG. 5 shows a device according to a third exemplary embodiment in an illustration based on FIG. 1a.

### DESCRIPTION OF PREFERRED EXEMPLARY EMBODIMENTS

### First Exemplary Embodiment

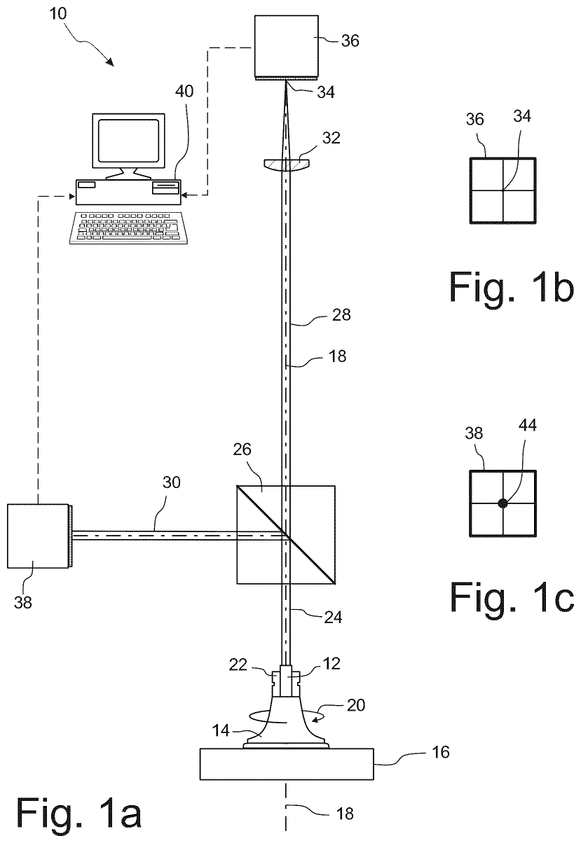

FIG. 1 schematically shows a device, denoted by 10 overall, for measuring alignment errors of a laser diode 12 according to a first exemplary embodiment of the invention.

The device comprises an alignment chuck 14 that can be put into rotation about an axis of rotation 18 with the aid of a drive 16, as indicated by an arrow 20 in FIG. 1. In other exemplary embodiments, the alignment chuck 14 is put into rotation by the drive 16 not directly but by way of a spindle (not depicted here).

The alignment chuck 14 carries a mounting 22 in which the laser diode 12 is secured, e.g. by adhesive bonding or screwing. The beam 24 generated by the laser diode is directed, which is tantamount to being collimated. As a result, the divergence of the beam 24 in the direction of propagation is so minor that it can be envisaged in beam optics terms as a bundle of parallel individual rays.

The beam 24 is split into a first component beam 28 and a second component beam 30 by a beam splitter 26. In this case, the split ratio may be e.g. 50:50.

A focusing optics unit 32 is arranged in the beam path of the first component beam 28; in FIG. 1a, said focusing optics unit is indicated by way of a single lens only, but it may also consist of a plurality of lenses and/or other optical elements. The focusing optics unit 32 is suitably positioned relative to the axis of rotation 18, e.g. centered, and focuses the first component beam 28 onto a focus 34 located in the plane of a first radiation sensor 36. The first radiation sensor 36 measures the incident radiation intensity in spatially resolved fashion and may be designed as a CCD camera or as a PSD sensor, for example.

The second component beam 30 is not focused but incident directly on a second radiation sensor 38, which is preferably constructed in the same way as the first radiation sensor 36. By way of data lines, the drive 16 and the two radiation sensors 36, 38 are connected to a computing means, indicated in FIG. 1a by a PC 40.

FIG. 1a implies that the optical axis of the beam 24 is exactly flush with the mechanical axis of the mounting 22, the latter being defined by the cylindrical external surface of the mounting 22 and in turn running coaxially with the axis of rotation 18. The centration of the by the external surface of the mounting 22 with respect to the axis of rotation 18 can easily be ensured by a type of “balancing”.

Hence, a rotation of the mounting 22 about the longitudinal axis 18 has no effects on the beam 24. As a result, the focus 34 of the first component beam 28 remains on the axis of rotation 18, as shown in the top view of the first radiation sensor 36 in FIG. 1b. In this case, the axis of rotation 18 is located at the point of intersection of the two crossed lines, which have only been plotted to aid orientation.

A stationary radiation spot 44 also arises on the second radiation sensor 38 (cf. FIG. 1c); the diameter of said radiation spot is larger than the focus 34 of the first component beam 28 on account of the lack of focusing.

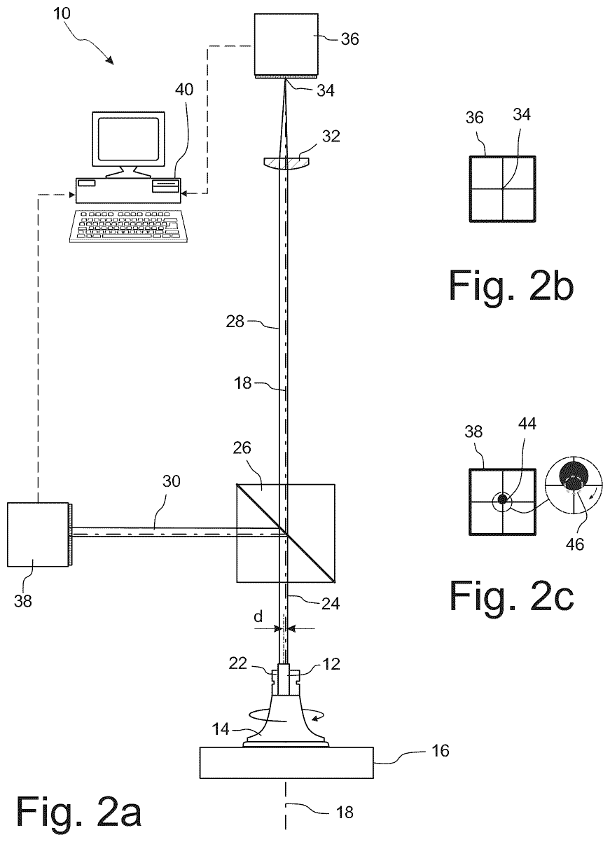

FIG. 2a shows the conditions in the event of the laser diode 12 in the mounting 22 being laterally offset by an absolute value d. In that case, the beam 24 is also offset accordingly with respect to the axis of rotation 18. As a consequence of this lateral offset, the optical axis of the beam 24 rotates in the event of a rotation of the alignment chuck 14 about the axis of rotation 24 but remains parallel thereto.

This has no effect on the first component beam 28 as the latter still runs parallel to the axis of rotation 18. As a comparison of FIGS. 2b and 1b shows, the focus 34 does not change its position as a consequence of the lateral offset.

On the second radiation sensor 38, by contrast, the lateral offset of the optical beam axis vis-à-vis the axis of rotation 18 is identifiable by virtue of the fact that the light spot 44 is no longer centered but performs a rotational movement about the axis of rotation 18 (angled through 90°), as may be identified in FIG. 2c. The center of the light spot 44 describes a circle of incidence 46, the half diameter of which corresponds to the lateral offset d. The intensity distributions recorded by the second radiation sensor 38 during the rotation of the alignment chuck 14 are evaluated by the computing means 40 in order to ascertain the diameter of the circle of incidence 46.

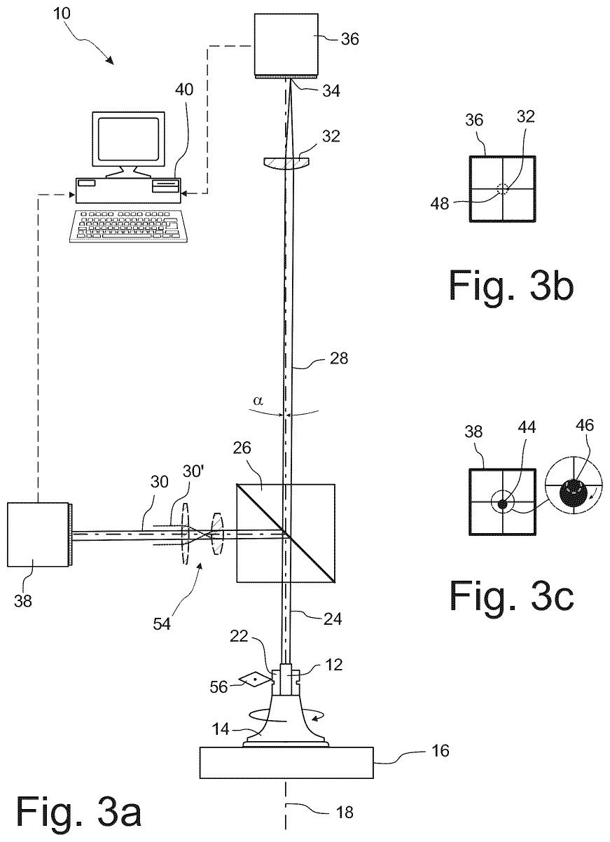

FIG. 3a shows the conditions when the optical axis of the beam 24 is tilted through an angle α vis-à-vis the axis of rotation 18. During the rotation of the alignment chuck 14, the focus 34 describes a circle of incidence 48, the diameter D of which is linked to the focal length f of the focusing optics unit 32 and the tilt angle α by way of the following relation-ship:

$$α \approx D / 2 \cdot f$$

In the event of a tilt, the light spot 44 arising on the second radiation sensor 38 also describes a circle of incidence, as shown in FIG. 3c. In this case, too, the tilt angle & could be derived from the diameter of the circle of incidence 50.

In general, the lateral offset illustrated in FIG. 2a and the tilt of the beam illustrated in FIG. 3a do not occur separately but together. However, in that case, too, the tilt is ascertained exclusively by evaluating the circle of incidence 48 described on the first radiation sensor 36 by the focus 34 of the first component beam 28.

In this case, the movements of the light spot 44 arising due to the offset and the tilt are superimposed on the second radiation sensor 38. Since the tilt angle α is known with great accuracy from measuring the first component beam 28, its effect on the circle of incidence 46 of the light spot 44 can be removed by calculation. In this way, the lateral offset d can be calculated on the basis of the locations on the second radiation sensor 38 swept over by the light spot 44 during the rotation.

### Second Exemplary Embodiment

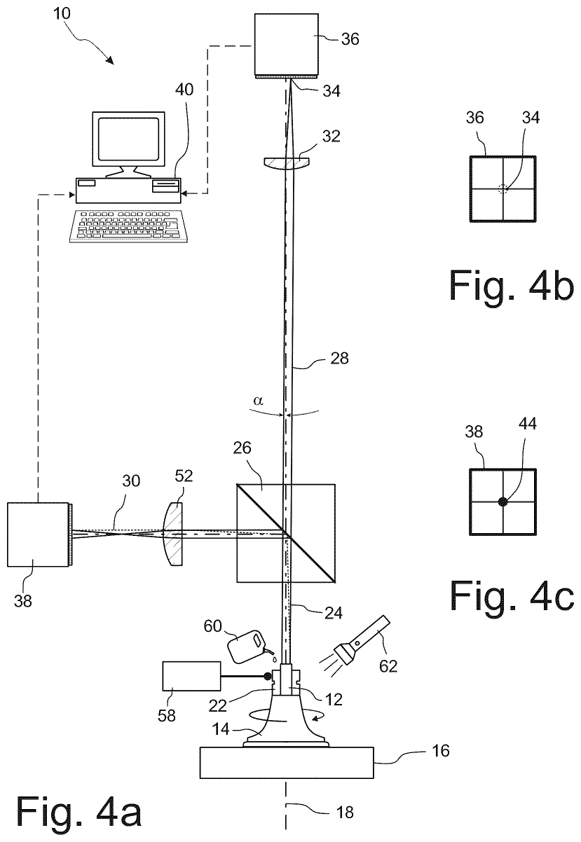

FIG. 4 shows an option for dispensing with the removal by calculation of the movement component caused by the tilt if an imaging optics unit 52, which is arranged centered with respect to the (angled) axis of rotation 18 and only indicated here by way of a lens, is introduced into the beam path of the second component beam 30. The imaging optics unit 52 is designed such that the laser diode 12 with its light-exit window is imaged onto the second radiation sensor 38. In this way, a tilt of the beam 24 no longer has any influence on the location of the light spot 44 on the second radiation sensor 38.

If no lateral offset is present, the light spot 44 is at rest on the angled axis of rotation 18. Should an offset d≠0 be present, the light spot 44 describes a circular trajectory around the angled axis of rotation 18, from which the lateral offset d can be derived when the imaging scale of the imaging optics unit 52 is taken into account.

### Further Variants

An afocal optics unit, e.g. a telescope, may additionally be provided in the exemplary embodiments described above. It can be used to adapt the beam angle and the beam diameter of the ray bundle emanating from the beam source 12. In this case, the afocal optics unit may be arranged e.g. in the beam path of the beam 24 between the beam source 12 and the beam splitter 26, whereby it is possible to influence the beam angle and beam diameter of both component beams 28, 30.

FIG. 3a shows an afocal optics unit that is denoted by 54, indicated using dashed lenses and indicated in the beam path of the second component beam 30. The afocal optics unit 54 is designed such that the second component beam 30 can be expanded to form a second component beam 30′ with a larger beam diameter, as indicated using dotted lines.

After the measurement has been performed, the beam source 12 can be aligned relative to the axis of rotation 18. Should the beam source 12 already be adhesively bonded, or in any other way connected, to the mounting 22 during the measurement, fine turning with the aid of a machining tool, as indicated at 56 in FIG. 3a, is a natural choice.

Another option of alignment is illustrated in FIG. 4a. Should the beam source 12 still be accommodated loosely, i.e. non-firmly, in the mounting 22 during the measurement, the beam source 12 can still be aligned in the mounting 22 after the measurement. To this end, the pose of the mounting 22 is initially measured in optical or tactile fashion with the aid of a distance sensor 58, and an adhesive is introduced into the gap between mounting 22 and beam source 12 with the aid of a dispenser 60. Following the alignment, the adhesive is cured, e.g. by irradiation with UV light from a UV lamp 62.

### Third Exemplary Embodiment

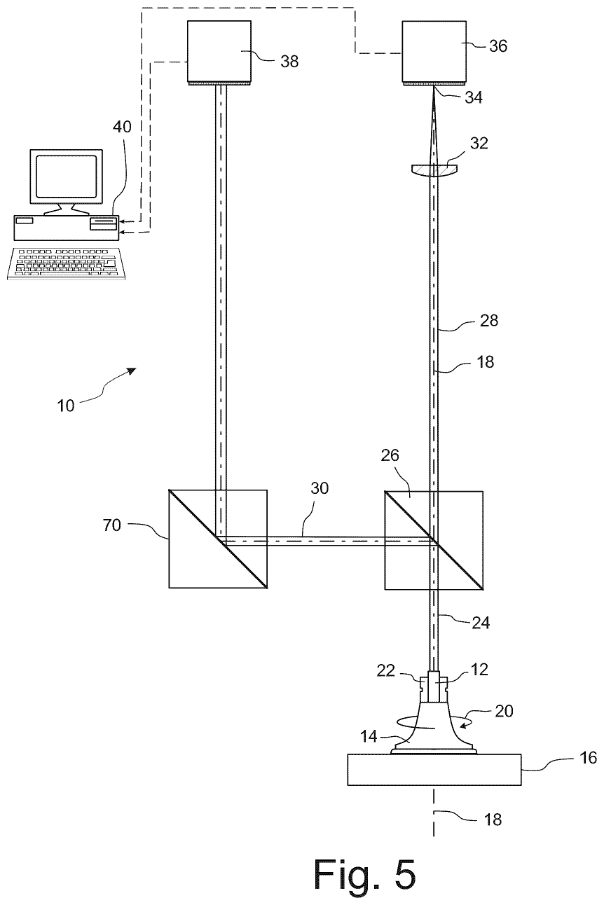

A further exemplary embodiment of a device according to the invention is depicted in FIG. 5. In this exemplary embodiment, a deflection prism 70 is situated in the beam path of the second component beam 30. The deflection prism 70 ensures that the component beam 30 is deflected in such a way that the latter extends approximately parallel to the first component beam 28 downstream of the deflection prism 70. To this end, the deflection prism 70 deflects the component beam 30, for example through an angle between 85° and 95° and preferably through an angle of 90°. Such a parallel beam path of the component beams 28, 30 allows a mechanically particularly compact construction of the entire device 10.

Otherwise, the device 10 depicted in FIG. 5 corresponds to the device 10 that is depicted in FIG. 1a and has already been explained above, and so it is possible to manage without a renewed description at this point.

It is understood that the deflection prism 70 can be introduced into each one of the above-described exemplary embodiments. In order to deflect the component beam 30, use can also be made of a deflection mirror or any other reflective optical element instead of a deflection prism 70.

1. A device for measuring alignment errors of a directed beam source the device comprising:
a mounting for the beam source,
a first spatially resolving radiation sensor,
a beam splitter configured to split a beam generated by the beam source into a first component beam and a second component beam,
a focusing optics unit arranged in a beam path of the first component beam and having a focal plane in which the first radiation sensor is arranged,
a second spatially resolving radiation sensor arranged in a beam path of the second component beam,
a drive configured to bring about relative movement about an axis of rotation between firstly the mounting and secondly the other parts of the device listed above,
a computing means configured to calculate a tilt and a lateral offset of the beam generated by the beam source the calculation using first locations on the first radiation sensor that the first component beam sweeps over during a rotation of the beam source relative to the other parts of the device listed above and using second locations on the second radiation sensor that the second component beam sweeps over during the rotation of the beam source relative to the other parts of the device listed above.

2. The device as claimed in claim 1, having an imaging optics unit arranged in the beam path of the second component beam and configured to image the beam source onto the second radiation sensor.

3. The device as claimed in claim 2, wherein the imaging optics unit is configured to image the beam source onto the second radiation sensor in either demagnified or magnified fashion.

4. The device as claimed in claim 1, wherein the mounting is supported by an alignment chuck with the aid of which the mounting can be aligned.

5. The device as claimed in claim 1, having an afocal optics unit that is arranged in the beam path of the beam generated by the beam source, of the first component beam or of the second component beam. 6. The device as claimed in claim 1, having a beam deflection unit that deflects the second component beam in such a way that the deflected second component beam runs at least approximately parallel to the first component beam.

7. A method for measuring alignment errors of a directed beam source the method comprising:
a) the beam source is inserted into a mounting and a relative rotation about an axis of rotation is generated;
b) concurrently with step a), a beam generated by the beam source is split into a first component beam and a second component beam by a beam splitter;
c) by means of a focusing optics unit the first component beam is directed at a first spatially resolving radiation sensor arranged in a focal plane of the focusing optics unit;
d) the second component beam is directed at a second spatially resolving radiation sensor; and
e) a tilt and a lateral offset of the beam generated by the beam source are calculated using first locations on the first radiation sensor that the first component beam sweeps over during the relative rotation and using second locations on the second radiation sensor that the second component beam sweeps over during the relative rotation of the beam source.

8. The method as claimed in claim 7, wherein the beam source is imaged onto the second radiation sensor.

9. The method as claimed in claim 8, wherein the beam source is imaged in demagnified or magnified fashion onto the second radiation sensor.

10. The method as claimed in claim 7, wherein the angles and the beam diameter of the beam generated by the beam source, of the first component beam and/or of the second component beam are set with the aid of an afocal optics unit.

11. The method as claimed in claim 7, wherein the beam source is aligned relative to the axis of rotation after step d).

12. The method as claimed in claim 11, wherein the beam source is firmly connected to the mounting before steps a) to d), and the alignment relative to the axis of rotation is effected with the aid of a tool by machining an external surface of the mounting.

13. The method as claimed in claim 11, wherein the beam source is inserted loosely into the mounting and the alignment relative to the axis of rotation is effected by virtue of the addition of an adhesive being followed by the beam source being brought into a desired position relative to the mounting with the aid of an alignment chuck, a hexapod or any other alignment means and the adhesive subsequently being cured.
